(19) United States
(12) Patent Application Publication
(10) Pub. No.: US 2017/0180440 A1
(43) Pub. Date: Jun. 22, 2017

(54) INFORMATION MANAGEMENT SYSTEM AND METHOD OF DELIVERING DATA ASSOCIATED WITH MACHINE

(71) Applicant: Caterpillar Inc., Peoria, IL (US)

(72) Inventors: Robert F. Schulz, Dunlap, IL (US); Jeffrey A. Bettenhausen, Edwards, IL (US); Steven J. Buster, Knoxville, IL (US); John D. Parker, Peoria, IL (US); Wayne M. Bogart, Peoria, IL (US); Vamsi K. Pegatraju, Peoria, IL (US); Joshua Sprague, Chicago, IL (US)

(73) Assignee: Caterpillar Inc., Peoria, IL (US)

(21) Appl. No.: 14/977,847

(22) Filed: Dec. 22, 2015

(51) Int. Cl. H04L 29/06; H04L 12/24

(52) U.S. Cl. CPC H04L 65/60; H04L 41/0803

(57) ABSTRACT

A method of delivering data associated with a machine to an off board system is provided. The method includes capturing data by an on board system of the machine from at least one of a sensing unit, a control unit and an indication unit of the machine. The method further includes defining a data packet includes a payload and a data identifier. The payload includes the captured data. The method further includes determining one or more transfer parameters associated with the machine by the on board system and streaming the data packet based on the one or more transfer parameters by the on board system. The method further includes transferring the data packet from the on board system to a gateway and delivering the data to the off board system by the gateway.

### TECHNICAL FIELD

The present disclosure relates to an information management system and methods of delivering data associated with a machine operating at a worksite.

### BACKGROUND

Generally, data related to operations of a particular machine operating at a worksite are managed using various systems. Such systems may have one or more components located at different locations for managing the data. For instance, the systems may include a data collecting unit located in the machine, whereas the data may be stored in a server located at a cloud implemented platform. Similarly, the system may also include web based applications which may be launched via communication devices such as mobile phones and laptops for providing access of data to a user. In such a scenario, transfer of data among various components may be troublesome and costly.

U.S. Pat. No. 6,975,928 describes Multi-mode in-vehicle control unit with network selectivity for transmitting vehicle data for fleet management. The multi-mode in-vehicle control unit (ICU) contains a plurality of modems. Each modem allows the multi-mode ICU to transmit vehicle data over a different kind of transmission network. The transmission networks include wireless data networks, cellular telephone networks and satellite networks. The multi-mode ICU selects one of the modems for transmission of vehicle data to a processing center.

### SUMMARY OF THE DISCLOSURE

In one aspect of the present disclosure, a method of delivering data associated with a machine to an off board system is provided. The method includes capturing data by an on board system of the machine from at least one of a sensing unit, a control unit and an indication unit of the machine. The method further includes defining a data packet that includes a payload and a data identifier. The payload includes the captured data. The method further includes determining one or more transfer parameters associated with the machine by the on board system and streaming the data packet based on the one or more transfer parameters by the on board system. The method further includes transferring the data packet from the on board system to a gateway and delivering the data to the off board system by the gateway.

In another aspect of the present disclosure, an information management system associated with a machine operating at a worksite is provided. The information management system includes an on board system. The on board system is configured to capture data from at least one of a sensing unit, a control unit and an indication unit of the machine. The on board system is further configured to define a data packet that includes a payload and a data identifier. The one board system is also configured to determine one or more transfer parameters associated with the machine and stream the data packet based on the one or more transfer parameters. The information management system further includes a gateway in communication with the on board system. The gateway is configured to receive the data packet from the on board system. The information management system further includes an off board system. The off board system is in communication with the gateway. The off board system is configured to receive the data delivered by the gateway.

In yet another aspect of the present disclosure, a computer program product embodied in a computer for delivering data associated with a machine to the off board system is provided. The computer program product causing the computer to perform operations includes capturing data from at least one of a sensing unit, a control unit and an indication unit of the machine by an on board system of the machine. The operations further include defining a data packet including a payload and a data identifier. The payload includes the captured data. The operations further include determining one or more transfer parameters associated with the machine by the on board system. The operations further include streaming the data packet based on the one or more transfer parameters by the on board system and transferring the data packet from the on board system to a gateway. The operations also include delivering the data to the off board system by the gateway.

Other features and aspects of this disclosure will be apparent from the following description and the accompanying drawings.

### BRIEF DESCRIPTION OF THE DRAWINGS

FIG. 1 is a block diagram showing an information management system of a machine, according to an embodiment of the present disclosure;

FIG. 2 is a block diagram of an on board system of the information management system of FIG. 1, according to an embodiment of the present disclosure;

FIG. 3 is a block diagram of an exemplary control system of the on board system of FIG. 2, according to an embodiment of the present disclosure;

FIG. 4 is a block diagram of a gateway of the information management system of FIG. 1, according to an embodiment of the present disclosure;

FIG. 5 is a flow diagram illustrating steps involved in data transfer from the on board system, according to an embodiment of the present disclosure;

FIG. 6 is a flow diagram illustrating steps involved in dynamic update of a transfer parameter file related to data transfer from the on board system, according to an embodiment of the present disclosure;

FIG. 7 is a flow diagram illustrating steps involved in configuring a transfer parameter file related to data transfer from the on board system, according to an embodiment of the present disclosure;

FIG. 8 is a flow diagram illustrating steps involved in configuration of information management system using the gateway, according to one embodiment of the present disclosure;

FIG. 9 is a flow diagram illustrating steps involved in configuration of information management system from the off board system, according to another embodiment of the present disclosure; and

FIG. 10 is a flow chart illustrating a method of delivering data associated with the machine, operating at the worksite, according to another embodiment of the present disclosure.

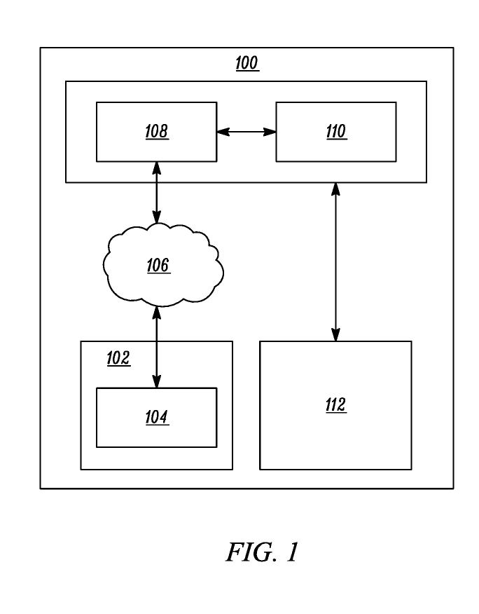

### DETAILED DESCRIPTION

Wherever possible, the same reference numbers will be used throughout the drawings to refer to the same or the like parts. FIG. 1 is a block diagram showing an information management system 100 of a machine 102. The machine 102 may be an engine system, a third party equipment and the like. The information management system 100 is configured to capture data from of the machine 102 deployed at a worksite (not shown). The information management system 100 is further configured to deliver the captured data for analyzing various parameters of the machine 102 such as, but not limited to, health and performance. The machines 102 deployed at the worksite are configured to perform one or more operations such as, drilling of materials, or transportation of material from one location to another. The worksite may be, for example, a mine site, a water body and a terrain. In an embodiment, the machine 102 may be in communication with a number of telematics data providers (not shown) for monitoring and/or controlling one or more functions of the machine 102.

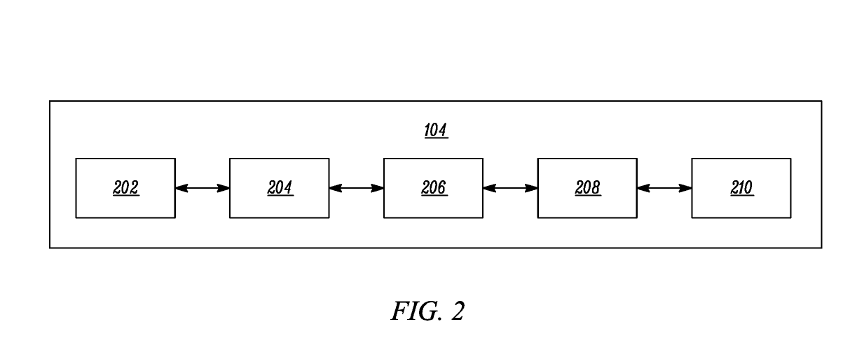

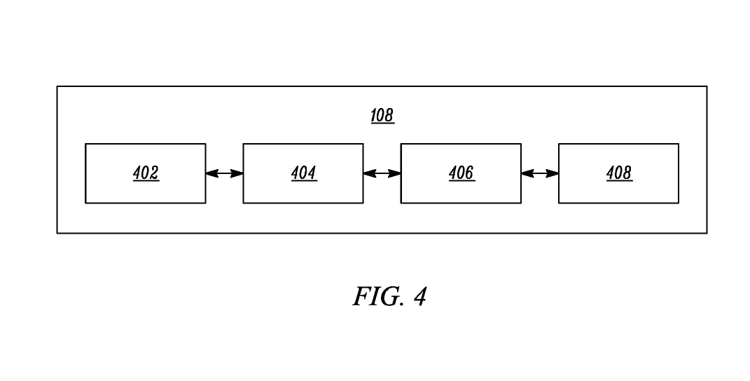

An on board system 104 is deployed in the machine 102 for accessing the data of the machine 102. Further, the on board system 104 communicates the data to the information management system 100. The on board system 104 is configured to capture and transfer data associated with the machine 102. The on board system 104 is described in detail with reference to FIG. 2. The on board system 104 of the machine 102 is communicated to a gateway 108 via a communication medium 106. The gateway 108 is configured to store the data received from the on board system 104 and provide access to the stored data based on a user requirement. The gateway 108 is described in detail with reference to FIG. 4. The gateway 108 is communicated to an off board system 110.

The off board system 110 is a software based solution that ties the on board system 104 and the gateway 108 together to deliver results for an operation of the machine 102 to a user. The off board system 110 may be configured to enable a user interaction with the information management system 100. The off board system 110 may include a web application module (not shown). The web application module may be defined based on a web based application. The web application module may include web based applications such as, but not limited to, a third party data provider, a reporting tool and a statistical analysis system (SAS) system. The off board system 110 of the information management system 100 may be accessed through a portable computing device, such as mobile phone, tablet, laptop, and the like. The web application module may be accessed by using authentication information, for example, a username and a password.

The off board system 110 is enabled to categorize and evaluate the data of the machine 102. In one example, the off board system 110 may be used for delivering the data for a single machine. In another example, the off board system 110 may be enabled to provide the software based solution to multiple machines deployed at the worksite. The off board system 110 may provide a custom fleet production report and a maintenance report. The off board system 110 may include multiple analysis tools, which assist the conversion of the data into decisions. The off board system 110 further includes an event list (not shown) and an event recorder (not shown) for recording events that occur during the operation of the machine 102. The off board system 110 may also include a data logger (not shown) for capturing the real time machine data based on user requirements. The data logged using the data logger may be used for troubleshooting an intermittent machine problem.

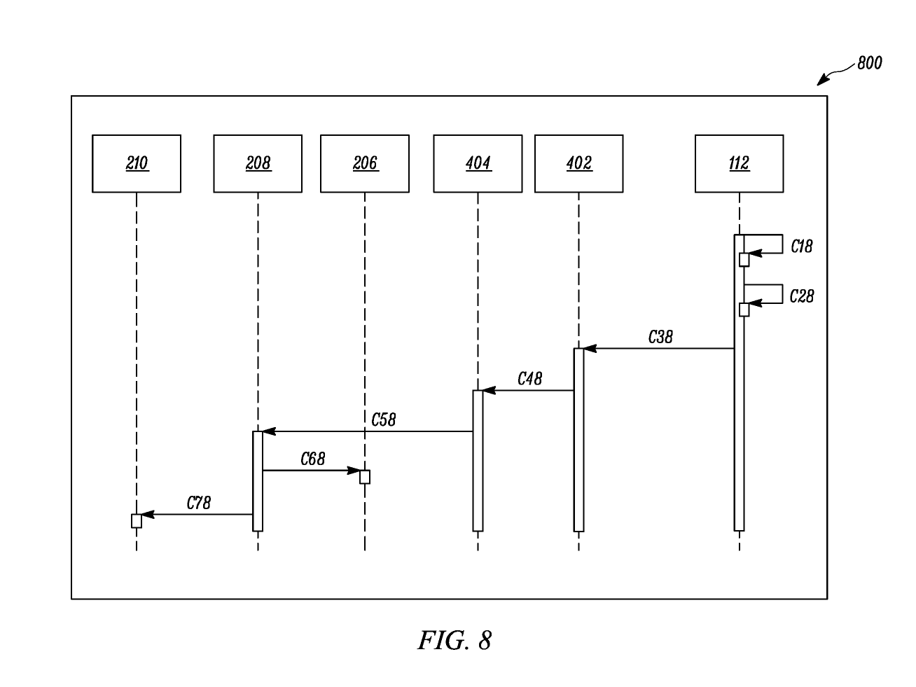

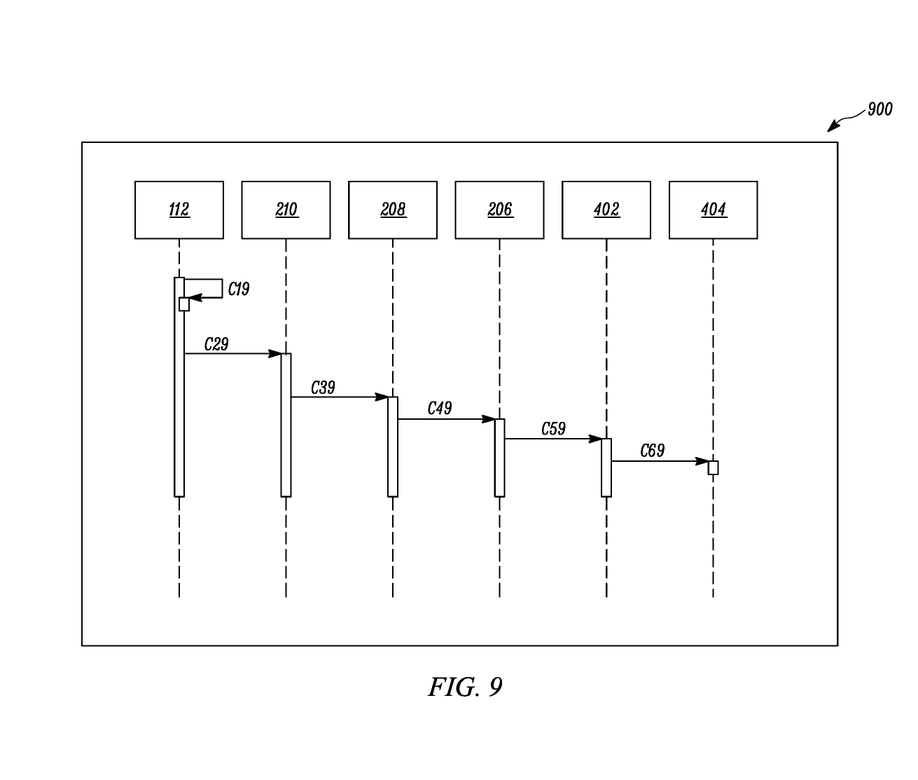

The information management system 100 further includes a system configuration editor 112. The system configuration editor 112 is enabled to configure the information management system 100. In one embodiment, the system configuration editor 112 is communicated with the gateway 108 for configuring the information management system 100. One or more method steps involved in configuring the information management system 100 by the system configuration editor 112 via the gateway 108 are explained in detail in FIG. 8. In another embodiment, the system configuration editor 112 is communicated to the off board system 110 for configuring the information management system 100. One or more method steps involved in configuring the information management system 100 by the system configuration editor 112 via the off board system 110 are explained in detail in FIG. 9.

The information management system 100 of the machine 102 is exemplary and should not limit the scope of the present disclosure. The functionality of the information management system 100 described herein is also exemplary. The information management system 100 may additionally include other components and capabilities not described herein. The worksite may additionally include any number of information management systems 100. Further, the architecture and capabilities of the information management system 100 may vary without any limitation.

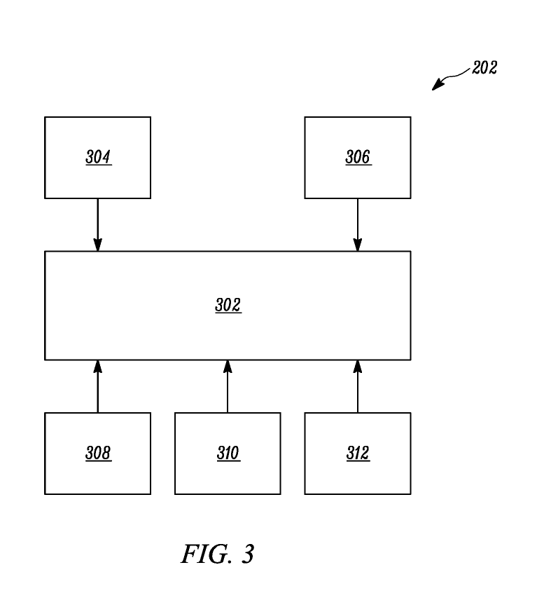

FIG. 2 is a block diagram of the on board system 104 of the information management system 100. The on board system 104 includes a control system 202. In one example, the control system 202 is enabled to communicate with, but not limited to, various control units of machine, a worksite system, customer assets and competitive machines. The control system 202 is configured to capture the data from the machine 102. The control system 202 is described in detail with reference to FIG. 3.

The on board system 104 further includes a streaming data engine 204 communicated to the control system 202. The streaming data engine 204 collects the captured data from the control system 202. The streaming data engine 204 is configured to define a data packet (not shown) based on the captured data. The data packet defined by the streaming data engine 204 comprises a payload (not shown) and a data identifier (not shown). The payload comprises the captured data from the control system 202. The streaming data engine 204 is further configured to determine one or more transfer parameters associated with the machine 102. The one or more transfer parameters includes, but not limited to, a set of data to be transferred, the communication medium 106 for transferring the set of data, a data transfer rate, a response interval between two consecutive data transfers, and a reporting rule.

The one or more transfer parameters are described in detail along with the significance without limiting the scope of the present disclosure. The set of data to be transferred may be categorized based on various parameters including, but not limited to, data received from one or more components of the control system 202 disclosed in FIG. 3. In one example, the set of data may include control information gathered from one or more control units and sensing units disposed in the control system 202.

The communication medium 106 for transferring the set of data is selected based on specification of the machine 102 and the worksite. In one example, the communication medium 106 is determined based on a connectivity of the machine 102 and the worksite. In another example, the communication medium 106 may be determined based on a size of data to be transferred. Examples of the communication medium 106 may include, but are not limited to, a wide area network (WAN), a local area network (LAN), Wi-Fi, an ethernet, an internet, an intranet, a cellular network, a satellite network, or any other known communication medium for transmitting and receiving data. In various embodiments, the communication medium 106 may include a combination of two or more of the aforementioned networks and/or other types of networks known in the art. Further, the communication medium 106 may be implemented as a wired network, a wireless network, or a combination thereof. Further, data transfer may take place over the communication medium 106 with a network protocol such that the data transfer may be in an encrypted format or any other secure format, or in any of a wide variety of known manners.

The data transfer rate is measured based on the communication medium 106 selected for transferring the data. The data transfer rate may vary according to the set of data selected for transfer. The response interval between two consecutive data transfer may be determined based on at least one of a state of the control system 202 of the machine 102, a remote command, and an update command. In one example, the captured data may be transferred when the control system 202 is activated. In another example, the captured data is transferred based on a remote command received from remote devices such as, but not limited to, the off board system 110 and/or the gateway 108. In yet another example, the captured data is transferred as a one-time update.

The transfer of data from the on board system 104 also depends on the reporting rule. The reporting rule may be determined based on an input from at least one of a user and the gateway 108. In one example, the reporting rule may be defined by the user based on user preferences. In another embodiment, the reporting rule may be updated by a manufacturer of the machine 102 and/or a service provider.

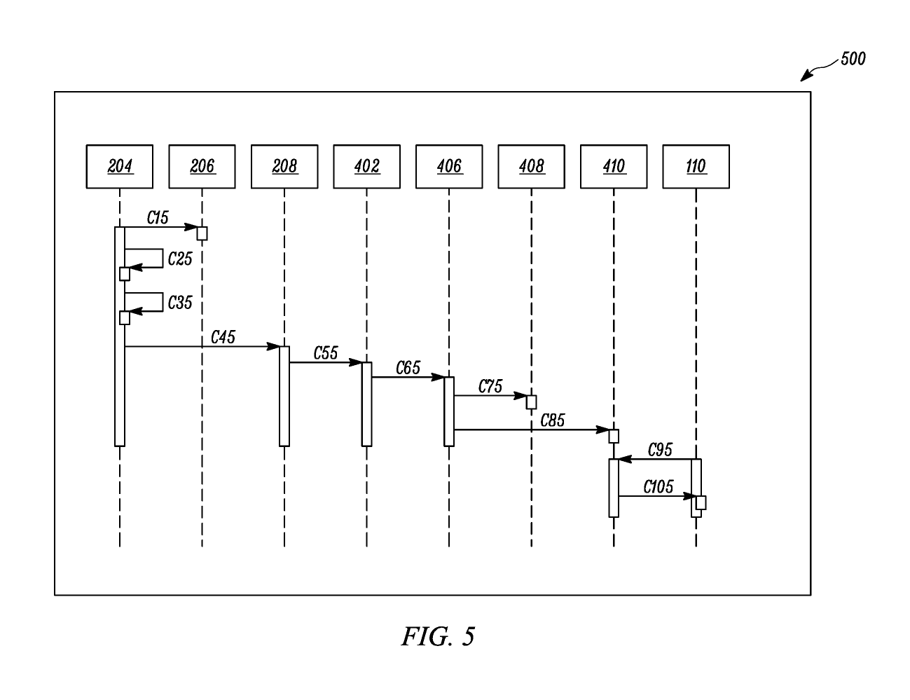

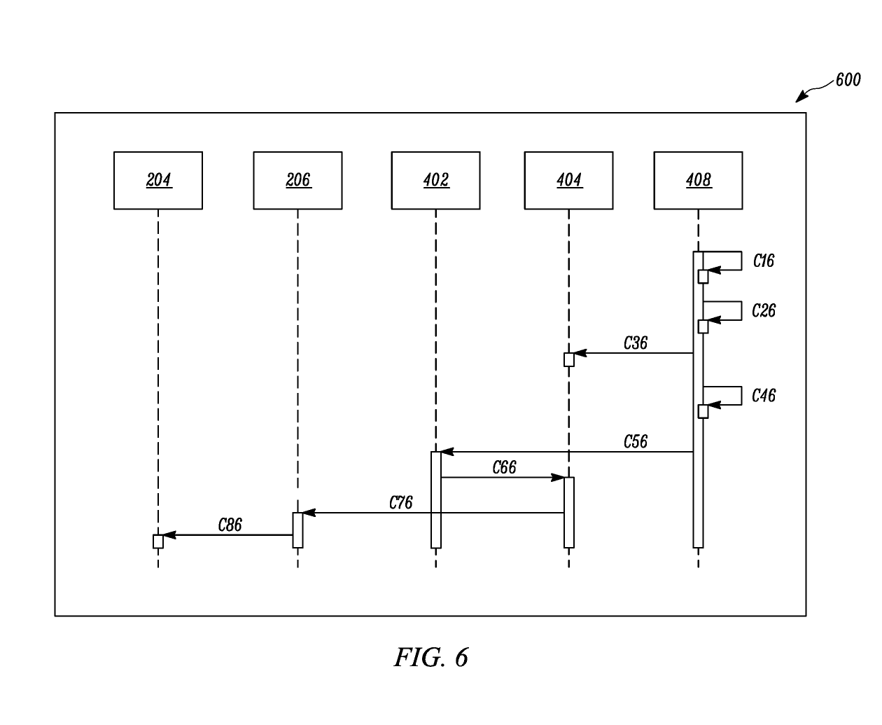

The on board system 104 further includes an on board file synchronizing module 206 communicated to the streaming data engine 204. The on board file synchronizing module 206 is configured to synchronize a transfer parameter file. It is to be noted that various aspects of the on board file synchronizing module 206 are explained in detail in FIG. 5, FIG. 6, FIG. 8, and FIG. 9. The on board system 104 further includes a file transfer manager 208. The file transfer manager 208 is communicated to the on board file synchronizing module 206. The file transfer manager 208 is enabled to transfer the data packet from the on board system 104 to the gateway 108.

The on board system 104 may include an information system configuration manager 210. The information system configuration manager 210 may be configured to manage an update of the information management system 100 of FIG. 1. The update of the information management system 100 may refer to an update or reconfiguration of different component of the information management system 100 such as the on board system 104, the off board system 110, and the gateway 108.

In one embodiment, the information system configuration manager 210 may be communicated to the system configuration editor 112 for updating the information management system 100. In such a scenario, the update of the information management system 100 is created by the system configuration editor 112. The updates are communicated to the information system configuration manager 210. The information system configuration manager 210 may store the update and execute the update in the on board system 104. This may be referred as local configuration of the information management system 100. The local configuration of the information management system 100 is explained in detail in FIG. 9.

In another embodiment, the information system configuration manager 210 may be communicated to the file transfer manager 208 for updating the information management system 100. In such a scenario, the system configuration editor 112 creates the update of the information management system 100 and communicates the update to the gateway 108. The update of the information management system 100 via the gateway 108 is explained in detail in FIG. 8.

In one embodiment, the on board system 104 includes ports wired data transfer among multiple components of the on board system 104. For wired data transfer, physical ports such as computer aided network ports are implemented without limiting the scope of present disclosure. In another embodiment, the on board system 104 may be configured with multiple wireless communication networks known in the art to communicate with a wireless telemetry system such as, but not limited to, terrain management system and fleet management system.

It may be contemplated that the streaming data engine 204, the on board file synchronizing module 206, the file transfer manager 208, and the information system configuration manager 210 described herein are exemplary. The functionalities performed by each of the streaming data engine 204, the on board file synchronizing module 206, the file transfer manager 208, and the information system configuration manager 210 be performed in combination without any limitation. Further, additional functionalities may be performed by any of the streaming data engine 204, the on board file synchronizing module 206, the file transfer manager 208, and the information system configuration manager 210.

FIG. 3 is a block diagram of the control system 202 of the on board system 104. The control system 202 is integrated with power train components and critical operations of the machine 102. The control system 202 includes a central data recorder 302 networked with various modules of the control system 202. The central data recorder 302 acquires data from the various modules of the control system 202 and stores and compares data against pre-programmed specifications and limits set by the user or the manufacturer of the machine 102. The control system 202 includes at least one electronic control unit (ECU) 304. The ECU 304 is an embedded system adapted to provide real time regulation for the machine 102 in which it is to be used. The ECU 304 may be adapted to control one or more operating parameters of the machine 102, without limiting the scope of the present disclosure.

The control system 202 includes a sensing unit 306. The sensing unit 306 may be communicated to the central data recorder 302. In one example, the sensing unit 306 may include an array of sensors (not shown). The sensing unit 306 is enabled to monitor various sensor data of the machine 102. The data of the machine 102 may include, but not limited to, pressure, oil content, temperature readings, engine rpm, hydraulic pressures, ground speed, and filter status. The sensor data from each of the sensor may be communicated to the control system 202. In one example, the sensing module includes communication with multiple third party equipment via standard protocols such as, but not limited to, public J1939, Modbus, and Profinet.

The control system 202 further includes a control unit 308. The control unit 308 is enabled to control multiple activities related to the machine 102 including, but not limited to, ground speed, steering control, and the like. The control unit 308 may include multiple control elements such as, but not limited to, road analysis control, trans/chassis control, and integrated braking control. The control unit 308 captures controlling data from each of the control elements and communicates the central data recorder 302. The control system 202 further includes an indication unit 310. The indication unit 310 is configured to indicate multiple operating conditions of the machine 102. The indication unit 310 may include multiple indication elements (not shown) such as, but not limited to, action lamp, service lamp, payload management lamp, service lamp, and service key switch.

The control system 202 further includes an user interaction unit 312 for receiving user input and providing measurement of various operating parameters of the machine 102. The user interaction unit 312 may include elements such as, but not limited to, keypad, speedo meter/tachometer, quad gauge, and message centre.

The control system 202 of the machine 102 may also include a telematics solution such as a transmission control module (not shown). The control system 202 may further include implement control module (not shown), hydraulic control module (not shown), customer drive equipment (not shown) such as a generator set attached to transmission and a natural gas compressor (not shown). The control system 202 described herein is exemplary. It may be contemplated that the control system 202 may include various modules having different functionalities performed in combination without any limitation.

FIG. 4 is a block diagram of the gateway 108 of the information management system 100. The gateway 108 is in communication with the on board system 104. The gateway 108 is configured to receive the data packet from the on board system 104 and deliver the data to the off board system 110. In an embodiment, the gateway 108 may be implemented as a web-based application. For example, the gateway 108 may be a cloud implemented platform hosted in one or more servers accessible to the users over the communication medium 106, such as the internet.

The gateway 108 includes a gateway server 402. The gateway server 402 is enabled to store the data packets received from the on board system 104. The gateway 108 further includes a gateway file synchronizing module 404. The gateway file synchronizing module 404 is enabled to communicate with the on board file synchronizing module 206 during the update of the information management system 100 as explained in FIG. 1. The gateway 108 also includes a transformation layer 406. During data transfer session from the on board system 104 to the gateway 108, the transmission layer 406 is configured to transform a machine readable raw data to a data packet corresponding to the one or more transfer parameters.

The transformation layer 406 is communicated to a command manager 408. In one embodiment, the command manager 408 is enabled to configure the one or more transfer parameters based on at least one of the user input and an update from the on board system 104 as depicted in FIG. 6. The command manager is configured to determine the one or more transfer parameters for the set of data to be transferred, description, unit and the like. In order to configure the one or more transfer parameters, the one or more transfer parameters are persisted and transferred as a single file. The single file generated by the command manager 408 may be defined as a transfer parameter file (not shown). The transfer parameter file includes a secure Hash algorithm (SHA) of the standard/customer configuration to identify one or more transfer parameters, a description corresponding to the machine 102, units of various machines 102 operating parameters and the like. The transfer parameter file also includes a command number for each of the transfer parameters to determine an associated UID64 for each of the values in a file response. The transfer parameter file is communicated to the on board system 104 by the command manager 408 of the gateway 108. Further, the one or more transfer parameters are updated at the on board system 104 based on the transfer parameter file. Upon updating the one or more transfer parameters, the on board system 104 sends the file response indicative of the update of the on board system 104 to the command manager 408.

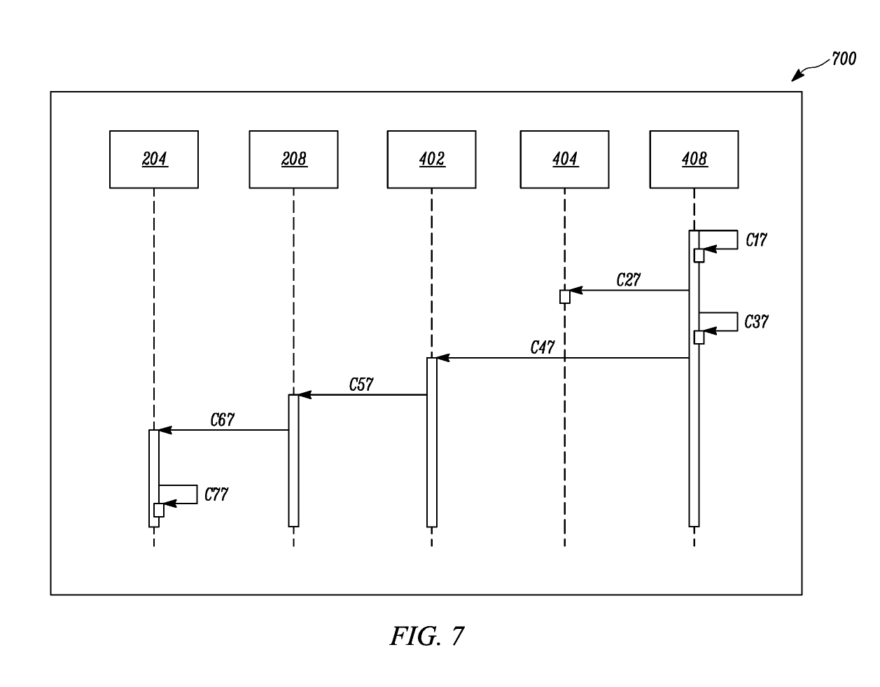

In another embodiment, the command manager 408 also generates a transfer parameter file update command that may be used to temporarily override an existing one or more transfer parameters as explained in FIG. 7. For instance, the transfer parameter file update command may include an update of data transfer rate. The data transfer rate depends on different states of the control system 202. The different states of the control system 202 may include “Turn On”, “Turn Off”. Similarly, the transfer parameter file update command may include an update on the response interval. The transfer parameter file update command may not be persisted across A5N2 restart or transfer parameter file changes/updates.

FIG. 5 illustrates a flow diagram 500 showing steps involved in data transfer from the on board system 104. The streaming data engine 204 sends a command C15 to the on board file synchronizing module 206. The command C15 is a Query File command. Further, the streaming data engine 204 executes a command C25. The command C25 includes instructions for processing the transfer parameter file. Upon processing the transfer parameter file, at a command C35, the streaming data engine 204 generates the data packet based on the one or more transfer parameter. Further, at a command C45, the streaming data engine 204 submits the data packet to the file transfer manager 208.

The file transfer manager 208 is enabled to transfer the data packet to the gateway 108 based on the one or more transfer parameters at a command C55. The data packet includes the data of the machine 102 and a data identifier. The gateway server 402 transfers the data packet to the transformation layer 406 at a command C65. At the transformation layer 406, the data packet is transformed based on the one or more transformation parameters, and an offset is applied to the data packet. Further, the data of the data packet is transformed to a string based on a command C75 received from the command manager 408.

The transformation layer 406 transfers the data to a subscription unit (not shown) by a command C85. In one example, the subscription unit may be a part of the gateway 108. In another example, the subscription unit may be a part of the off board system 110. The off board system 110 sends a command C95 to the subscription unit. The command C95 enables the off board system 110 to register the communication device (nor shown) through which the off board system 110 is accessed. Once the on board system 104 of the information management system 100 is registered with the subscription unit, the subscription unit transfers the data to the web application using a command C105.

FIG. 6 illustrates the flow diagram 600 showing steps involved in a dynamic update of the one or more transfer parameter of the transfer parameter file related to data transfer from the on board system 104. The said dynamic update is a command update that temporarily updates an existing transfer parameter file. The dynamic update overrides at least one of a transfer parameter in the existing transfer parameter file but not persist across reboots of the on board system 104. In order to provide the dynamic update on the existing one or more transfer parameters, the command manager 408 of the gateway 108 determines one or more transfer parameters based on the specification of the worksite and the machine 102. Further, the transfer parameter file is generated by the command manager 408 at a command C16. In one embodiment, the command manager 408 is also enabled to consider the user inputs for generating the transfer parameter file. Further, at a command C26, the command manager 408 verifies the transfer parameter file. The command C26 is executed to confirm whether the one or more transfer parameters of the information management system 100 matches with an existing one or more transfer parameter of the information management system 100. The command manager 408 sends a command C36 to the gateway file synchronizing module 404. Subsequently, at a command C46, the command manager 408 deploys the transfer parameter file. Once the command C46 is executed, the command manager 408 sends a command C56 to the gateway server 402. The command C56 includes a submit file instruction indicative of information regarding the size and specification of data packet to be transferred from the on board system 104. Then, the gateway server 402 sends a command C66. The command C66 indicates the receipt of the command C56.

Further, the gateway file synchronizing module 404 transfers a command C76 to the on board file synchronizing module 206. The command C76 includes the transfer parameter file including one or more transfer parameter. The on board file synchronizing module 206 transfers a command C86 to the streaming data engine 204 for processing the transfer parameter file.

FIG. 7 is a flow diagram 700 that illustrates steps involved in a configuration of the transfer parameter file related to the data transfer from the on board system 104. In order to configure the transfer parameter file, the command manager 408 creates the transfer parameter file update command. The transfer parameter file update commands are short lived, and mainly used to stream the data based on a preference of the communication device in which the off board system 110 is launched. Once the transfer parameter file update command is created at the command manager 408, the command manager 408 sends a command C27 to the gateway file synchronizing module 404. The command C27 includes a request file indicative of specification of the data packet. Then, the command manager 408 executes a command C37. The command C37 includes instructions for deploying the transfer parameter file update command in the command manager 408. Further, the transfer parameter file update command is transferred to the gateway server 402. In one example, the transfer parameter file update command includes multiple transfer parameter files. Each of such transfer parameter file update command may be identified by a command number. In the illustrated example, the transfer of transfer parameter file update command is identified by a command C47. The transfer parameter file update command is communicated to the file transfer manager 208 via a command C57. During a file transfer event, the file transfer manager 208 activates the configuration of the streaming data engine 204 using a command C67. The command C67 includes multiple instructions such as a file transfer event instruction, specification of the data to be transferred, and a constant character. Subsequently, a command C77, generated at the streaming data engine 204, configures the one or more transfer parameters corresponding to the transfer parameter file update command. The configuration of transfer parameter file provides a permanent change in the existing one or more transfer parameters in the information management system 100.

FIG. 8 illustrates the flow diagram 800 showing steps involved in configuration of the information management system 100 using the gateway 108, according to one embodiment. The information management system 100 undergoes periodic updates based on a characteristic of the worksite and the machine 102. The system configuration editor 112 of the information management system 100 is enabled to configure the said periodic updates. The update of various components of the information management system 100 may be defined as a configuration of the information management system 100.

The system configuration editor 112 creates a command C18 corresponding to an update of the information management system 100. Further, the system configuration editor 112 executes a command C28. The command C28 includes instructions for deploying the update. Once the updates are deployed in the system configuration editor 112, the system configuration editor 112 sends a command C38 indicative of file submission to the gateway server 402. The gateway server 402 communicates with the gateway file synchronizing module 404 regarding the update using a command C48. The gateway file synchronizing module 404 sends a command C58 in respect of the update to the file transfer manager 208 for updating the existing configuration. Upon the receipt of the command C58, the file transfer manager 208 generates the file response and communicates the file response to the on board file synchronizing module 206 via a command C68. The information system configuration manager 210 is communicated to the on board system 104 as explained in FIG. 2. The file transfer manager 208 sends a command C78 to the information system configuration manager 210 for updating the information system configuration manager 210.

FIG. 9 is a flow diagram 900 illustrating steps involved in configuration of the information management system 100 from the off board system 110, according to another embodiment. The configuration of the information management system 100 from the off board system 110 may also be defined as the local configuration of the information management system 100 as mentioned in FIG. 2. In order to configure the information management system 100 from the off board system 110, the system configuration editor 112 executes a command C19. The command C19 includes an instruction for creating an update for the information management system 100. In the local configuration of the information management system 100, the system configuration editor 112 is communicated to the information system configuration manager 210 of the on board system 104. The system configuration editor 112 sends a command C29 to the information system configuration manager 210. The command C29 includes an instruction for accepting the local configuration. The local configuration is communicated to the other components of the on board system 104 by the information system configuration manager 210. The information system configuration manager 210 sends a command C39 indicative of the local configuration to the file transfer manager 208. The file transfer manager 208 transfers a command C49 to the on board file synchronizing module 206. The command C49 includes instructions associated with the local configuration. Upon receiving the command C49, the on board file synchronizing module 206 sends a command C59 indicative of the local configuration to the gateway server 402. The command C59 includes information on the size of the data packet and specification of string. The local configuration is performed in the gateway file synchronizing module 404 using a command C69 received from the gateway server 402.

It is to be understood that individual features shown or described for one embodiment of the present disclosure may be combined with individual features shown or described for another embodiment of the present disclosure. The above described implementation does not in any way limit the scope of the present disclosure. Therefore, it is to be understood that although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the information management system 100 and a method 1000 for delivering data of the machine 102 with high integrity. The information management system 100 enables a streaming mechanism for data of the machine 102. The command manager 408 of the gateway 108 or the user may be enabled to determine the one or more transfer parameters to minimize carrier cost and maximize business value. The size of the data packet transferred over the information management system 100 is reduced by restricting the transfer of the metadata. Similarly, the communication medium 106 is selected based on a location of the machine 102 and/or the size of data to be transferred. In particular, the on board system 104 selects a low cost communication medium available to transfer the data from the on board system 104 to the gateway 108. The method 1000 according to present disclosure saves time, reduces cost and improves operations by monitoring machine health and machine operating conditions based on the delivered data from the machine 102.

The information management system 100 may be enabled to track equipment hours, usage, enhance work flows, enhance production cycles, and maximize equipment uptime. The on board system 104 captures machine data, delivers instant feedback to the operator and makes vital machine-generated data available for download. The off board system 110 is enabled to categorize and evaluate data of the machine 102 to efficiently manage performance, and productivity of the machine 102. The prompt data transfer over the information management system 100 may help maintenance personnel to take appropriate action to avoid machine damage, streamline maintenance operations, and improve overall operational efficiencies. The information management system 100 may be embodied as a computer program product in a computer. The computer program product is enabled to delivering data of the machine 102 deployed at the worksite.

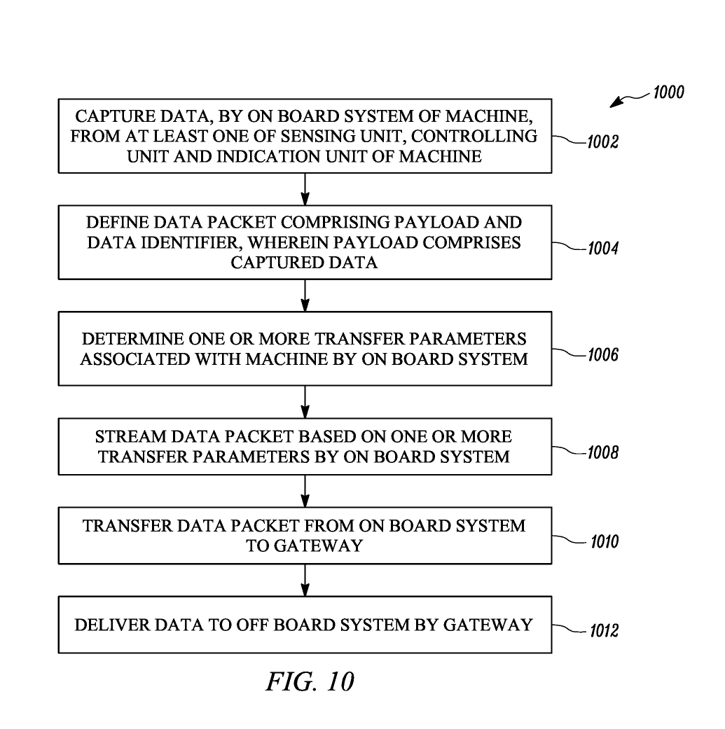

FIG. 10 is a flow chart illustrating the method 1000 of delivering data associated with the machine 102. The machine 102 includes the on board system 104. This enables the machine 102 to a part of the information management system 100 to establish a communication with the gateway 108 and the off board system 110. The information management system 100 needs to be configured using the system configuration editor 112, based on the one or more transfer parameters. The one or more transfer parameters are used for an enhanced data transfer among the on board system 104, the gateway 108, and the off board system 110.

At step 1002, the control system 202 of the on board system 104 captures the data from the machine 102. Further, at step 1004, the streaming data engine 204 of the on board system 104 defines a data packet. The data packet comprises a payload and a data identifier. The payload comprises the captured data from the control system 202.

Further, at step 1006, the streaming data engine 204 determines one or more transfer parameters associated with the machine 102 by the on board system 104. The step 1006 of determining one or more transfer parameters includes the following process. Primarily, the set of data to be transferred from the on board system 104 to the gateway 108 is identified. Further, the communication medium 106 for transferring the set of data based on information regarding the worksite is determined. Then, the data transfer rate is determined based on the communication medium 106. Thereupon, the response interval is determined based on at least one of a state of the control system 202 of the machine 102, a remote command from the user or the gateway 108, and an update command. Also, the reporting rule is determined based on an input from at least one of a user and the gateway 108.

In order to determine the one or more transfer parameters, the one or more transfer parameter may be configured in the information management system 100. The configuration of the one or more transfer parameters may be performed based on at least one of a user input and an update from the on board system 104. In order to configure the one or more transfer parameters, the following method steps are performed. Firstly, a transfer parameter file is generated based on the one or more transfer parameters by the command manager 408. The transfer parameter file is communicated to the on board system 104 by the gateway file synchronizing module 404. The one or more transfer parameters are updated in the streaming data engine 204 of the on board system 104 based on the transfer parameter file. Further, the command manager 408 receives the file response indicative of the update of the on board system 104. The configuration is communicated to the off board system 110 by the on board system 104.

At step 1008, the data packet is streamed by the streaming data engine 204 based on the one or more transfer parameters. At step 1010, the data packet is transferred from the file transfer manager 208 of the on board system 104 to the gateway 108. Then, at step 1012, the gateway 108 delivers the data to the off board system 110.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of delivering data associated with a machine, operating at a worksite, to an off board system, the method comprising:
capturing, by an on board system of the machine, data from at least one of a sensing unit, a control unit and an indication unit of the machine;
defining a data packet comprising a payload and a data identifier, wherein the payload comprises the captured data;
determining one or more transfer parameters associated with the machine by the on board system;
streaming the data packet based on the one or more transfer parameters by the on board system;
transferring the data packet from the on board system to a gateway; and
delivering the data to the off board system via the gateway.

2. The method of claim 1, further comprising: configuring the one or more transfer parameters based on at least one of a user input and an update from the on board system.

3. The method of claim 2, comprising:
generating a transfer parameter file based on the one or more transfer parameters;
communicating the transfer parameter file to the on board system;
updating the one or more transfer parameters of the on board system based on the transfer parameter file;
receiving a file response indicative of the update of the on board system; and
communicating the update of the on board system with the off board system.

4. The method of claim 1, wherein the one or more transfer parameters comprises a set of data to be transferred, a communication medium for transferring the set of data, a data transfer rate, a response interval between two consecutive sets of data transferred, and a reporting rule.

5. The method of claim 4, comprising:
identifying the set of data to be transferred from the on board system to the gateway;
determining the communication medium for transferring the set of data based on information regarding the worksite;
measuring the data transfer rate based on the communication medium;
determining the response interval based on at least one of a state of an electronic control system of the machine, a remote command, and an update command; and
determining the reporting rule based on an input from at least one of a user and the gateway.

6. The method of claim 1, further comprising configuring an information management system associated with the machine, using a system configuration editor, based on the one or more transfer parameters.

7. The method of claim 6, further comprising communicating the system configuration editor to at least one of the gateway and the off board system.

8. The method of claim 1, wherein the on board system comprises a control system, a streaming data engine, an on board file synchronizing module, and a file transfer manager.

9. The method of claim 1, wherein the off board system comprises a web application module.

10. The method of claim 1, wherein the gateway comprises a gateway server, a gateway file synchronizing module, a transformation layer, and a command manager.

11. An information management system associated with a machine, operating at a worksite, the information management system comprising:
an on board system configured to:
capture data from at least one of a sensing unit, a control unit and an indicating unit of the machine;
define a data packet comprising a payload and a data identifier, wherein the payload comprises the captured data;
determine one or more transfer parameters associated with the machine; and
stream the data packet based on the one or more transfer parameters;
a gateway in communication with the on board system, wherein the gateway is configured to receive the data packet from the on board system; and
an off board system in communication with the gateway, wherein the off board system is configured to receive the data delivered by the gateway.

12. The information management system of claim 11, wherein the gateway is configured to:
generate a transfer parameter file based on the one or more transfer parameters;
communicate the transfer parameter file to the on board system;
update the one or more transfer parameters of the on board system based on the transfer parameter file;
receive a file response from the on board system; and
communicate the update of the on board system with the off board system.

13. The information management system of claim 11, wherein the one or more transfer parameters comprises a set of data to be transferred, a communication medium for transferring the set of data, a data transfer rate, a response interval between two consecutive data transfers, and a reporting rule.

14. The information management system of claim 13, wherein the on board system is configured to:
identify the set of data to be transferred to the gateway;
determine the communication medium for transferring the set of data based on information regarding the worksite;
measure the data transfer rate based on the communication medium;
determine the response interval based on at least one of a state of an electronic control system of the machine, a remote command, and an update command; and
determine the reporting rule based on an input from at least one of an user and the gateway.

15. The information management system of claim 11, wherein the on board system comprises a control system, a streaming data engine, an on board file synchronizing module, and a file transfer manager.

16. The information management system of claim 11, wherein the off board system comprises a web application module.

17. The information management system of claim 11, wherein the gateway comprises a gateway server, a gateway file synchronizing module, a transformation layer, and a command manager.

18. The information management system of claim 11, further comprising a system configuration editor communicated to at least one of the gateway and the off board system, wherein the system configuration editor is configured to update the information management system.

19. A computer program product embodied in a computer for delivering data associated with a machine, operating at a worksite, to an off board system, the computer program product causing the computer to perform operations comprising:
capturing, by an on board system of the machine, data from at least one of a sensing unit, a control unit and an indication unit of the machine;
defining a data packet comprising a payload and a data identifier, wherein the payload comprises the captured data;
determining one or more transfer parameters associated with the machine by the on board system;
streaming the data packet based on the one or more transfer parameters by the on board system;
transferring the data packet from the on board system to a gateway; and
delivering the data to the off board system by the gateway.

20. The computer program product of claim 19, comprising:
generating a transfer parameter file based on the one or more transfer parameters;
communicating the transfer parameter file to the on board system;
updating the one or more transfer parameters of the on board system based on the transfer parameter file;
receiving a file response indicative of the update of the on board system; and
communicating the update of the on board system with the off board system.
